(19) United States
(12) Patent Application Publication
(10) Pub. No.: US 2022/0281348 A1
(43) Pub. Date: Sep. 8, 2022

(54) BATTERY MANAGEMENT SYSTEM, BATTERY DEVICE, BATTERY MANAGEMENT METHOD, AND COMPUTER PROGRAM

(71) Applicant: SUMITOMO ELECTRIC INDUSTRIES, LTD., Osaka-shi, Osaka (JP)

(72) Inventor: Hiroki SASAKURA, Osaka-shi (JP)

(73) Assignee: SUMITOMO ELECTRIC INDUSTRIES, LTD., Osaka-shi, Osaka (JP)

(21) Appl. No.: 17/631,742

(22) PCT Filed: Jul. 29, 2020
(86) PCT No.: PCT/JP2020/029103

§ 371 Date: Jan. 31, 2022

(30) Foreign Application Priority Data
Aug. 20, 2019 (JP) 2019-150172

(51) Int. Cl. B60L 58/12; H01M 10/42

(52) U.S. Cl. CPC B60L 58/12; H01M 10/4257; H01M 2010/4271; H01M 2010/4278; H01M 2220/20; B60L 2240/70

(57) ABSTRACT

A battery management system is a battery management system managing a battery device loaded in a vehicle. The battery management system includes: a sensor configured to measure an ON time of a battery module included in the battery device, the sensor being included in the battery device; a communication device configured to send the ON time measured by the sensor to a management device, the management device managing the ON time of the battery module and receive a reference value from the management device; and a circuitry configured to judge whether the battery module has been used outside management of the management device, based on the ON time measured by the sensor and the reference value, wherein the communication device also sends a judging result determined by the circuitry to the management device.

### TECHNICAL FIELD

The present disclosure relates to a battery management system, a battery device, a battery management method, and a computer program. The present application claims priority from Japanese Patent Application No. 2019-150172 filed on Aug. 20, 2019, the entire contents of which are hereby incorporated by reference.

### BACKGROUND ART

Illegally removing a battery loaded in a vehicle, such as an electric car, a hybrid car, and a plug-in hybrid car, from the vehicle is becoming a problem. PTL 1 discloses the following power source device. This power source device includes a battery controller and plural battery modules and judges whether the unauthorized use of a battery module has occurred. In the power source device disclosed in PTL 1, each battery module includes a cell-controller. The cell-controller sends an authentication key to the battery controller and determines the unauthorized use of the battery module which includes this cell-controller in accordance with the result of authentication performed by the battery controller using the authentication key.

### CITATION LIST

### Patent Literature

PTL 1: International Publication No. 2014/027509

### SUMMARY OF INVENTION

A battery management system according to an aspect of the present disclosure is a battery management system managing a battery device loaded in a vehicle. The battery management system includes: a sensor configured to measure an ON time of a battery module included in the battery device, the sensor being included in the battery device; a communication device configured to send the ON time measured by the sensor to a management device, the management device managing the ON time of the battery module and receive a reference value from the management device; and a circuitry configured to judge whether the battery module has been used outside management of the management device, based on the ON time measured by the sensor and the reference value, wherein the communication device also sends a judging result determined by the circuitry to the management device.

The present disclosure may be implemented, not only as a battery device having the above-described distinctive configuration, but also as a detection method using distinctive processing executed in the battery device as steps and as a computer program causing a computer to execute these steps. The battery device may be partially or entirely implemented as a semiconductor integrated circuitry or as a battery management system including the battery device.

### BRIEF DESCRIPTION OF DRAWINGS

FIG. 1 is a schematic view illustrating an example of an ON-time management system according to an embodiment.

FIG. 2 is a block diagram illustrating an example of the configuration of an in-vehicle system loaded in a vehicle according to the embodiment.

FIG. 3 is a block diagram illustrating an example of the configuration of a battery management system according to the embodiment.

FIG. 4A is a circuit diagram illustrating an example of the configuration of a battery module according to the embodiment.

FIG. 4B is a circuit diagram illustrating another example of the configuration of the battery module according to the embodiment.

FIG. 5 is a functional block diagram illustrating an example of functions of a controller of a battery device according to the embodiment.

FIG. 6 is a diagram illustrating an example of the configuration of a database provided in each of a server and an in-vehicle control device according to the embodiment.

FIG. 7 is a flowchart illustrating an operation procedure of a measuring unit according to the embodiment.

FIG. 8 is a flowchart illustrating an example of a procedure of battery-module outside use judging processing executed by the controller according to the embodiment.

FIG. 9 is a flowchart illustrating an example of a procedure of ON-time providing processing executed by the controller according to the embodiment.

### DESCRIPTION OF EMBODIMENTS

### Problems to be Solved by Present Disclosure

In the power source device disclosed in PTL 1, a cell-controller is provided to judge the occurrence of the unauthorized use of a battery module. The cell-controller is a highly sophisticated circuit that can execute complicated judging processing for the unauthorized use. Such a cell-controller is provided in each of the plural battery modules, and thus, the configuration of the power source device disclosed in PTL 1 is complicated and is also expensive.

### Advantageous Effects of Present Disclosure

According to the present disclosure, it is possible to judge whether a battery module has been used outside the management of a management device while achieving a simple configuration of a battery device.

### Overview of Embodiment of Present Disclosure

An overview of an embodiment of the present disclosure will be described below.

(1) A battery management system according to the embodiment is a battery management system managing a battery device loaded in a vehicle. The battery management system includes: a measuring unit configured to measure an ON time of a battery module included in the battery device, the measuring unit being included in the battery device; a sending unit configured to send the ON time measured by the measuring unit to a management device, the management device managing the ON time of the battery module; and a judging unit configured to judge whether the battery module has been used outside management of the management device, based on the ON time measured by the measuring unit and a reference value provided from the management device. The sending unit also sends a judging result determined by the judging unit to the management device. The ON time of the battery module can be measured with a simple configuration using an ON-time detection circuit and a timer. It is thus possible to judge whether the battery module has been used outside the management of the management device while achieving a simple configuration of the battery device. “The use of the battery module outside the management of the management device” refers to the use of the battery module that is impossible to trace from the ON time of the battery module managed by the management device. For example, if the battery module is removed from the vehicle and is used outside the vehicle, the ON time of the battery module during such a use is not sent to the management device. The use of the battery module outside the vehicle is thus an example of the use of the battery module outside the management of the management device.

(2) The reference value may be a value based on the ON time of the battery module of a past sent from the sending unit to the management device. When the battery module is used outside the management of the management device, the ON time of the battery module is measured but is not sent to the management device. Hence, after the battery module is used outside the management of the management device, when the battery module is used again under the management of the management device, the resulting measured ON time becomes considerably different from the past ON time sent to the management device. As a result of setting the reference value to a value based on the past ON time sent to the management device, the difference between a currently measured ON time and the past ON time can be determined, thereby making it possible to accurately judge whether the battery module has been used outside the management of the management device.

(3) The measuring unit may measure the ON time for a period from when an in-vehicle system loaded in the vehicle is started until when it shuts down, and the sending unit may send the ON time at a timing when the in-vehicle system shuts down. With this configuration, the ON time is sent to the management device when the in-vehicle system shuts down, that is, when the driver finishes driving the vehicle. This can make the time interval from when the ON time is sent last time until when the ON time is measured this time small. It is thus possible to even more accurately judge whether the battery module has been used outside the management of the management device. If the in-vehicle system is started multiple times, the ON time may be the cumulative value of the past ON times. That is, the value of the ON time measured at the shutdown time of the in-vehicle system may be retained, and when the in-vehicle system is started next time, measurement may be restarted from the retained value of the ON time.

(4) At a timing when the in-vehicle system is started, the judging unit may obtain the reference value from the management device and judge whether the battery module has been used outside the management of the management device. With this configuration, when the in-vehicle system is started, that is, when the driver starts driving the vehicle, the judging unit makes the above-described judgement. This can make the time interval from when the ON time is sent last time until when the ON time is measured this time small. It is thus possible to even more accurately judge whether the battery module has been used outside the management of the management device.

(5) The measuring unit may measure the ON time when a current of a prescribed value or greater is output from the battery module. With this configuration, the ON state and the OFF state of the battery module can be clearly distinguished from each other. The ON time can thus be measured accurately.

(6) A battery device according to the embodiment is a battery device loaded in a vehicle. The battery device includes: a battery module; a measuring unit configured to measure an ON time of the battery module; a sending unit configured to send the ON time measured by the measuring unit so as to provide the ON time to a management device, the management device managing the ON time of the battery module; and a judging unit configured to judge whether the battery module has been used outside management of the management device, based on the ON time measured by the measuring unit and a reference value provided from the management device. The sending unit also sends a judging result determined by the judging unit so as to provide the judging result to the management device. The ON time of the battery module can be measured with a simple configuration using an ON-time detection circuit and a timer. It is thus possible to judge whether the battery module has been used outside the management of the management device while achieving a simple configuration of the battery device.

(7) A battery management method according to the embodiment is a battery management method for managing a battery device loaded in a vehicle. The battery management method includes: a step of measuring an ON time of a battery module included in the battery device; a step of sending the measured ON time to a management device, the management device managing the ON time of the battery module; and a step of judging whether the battery module has been used outside management of the management device, based on the measured ON time and a reference value provided from the management device. The step of sending the measured ON time further includes sending of a judging result indicating whether the battery module has been used outside the management of the management device to the management device. The ON time of the battery module can be measured with a simple configuration using an ON-time detection circuit and a timer. It is thus possible to judge whether the battery module has been used outside the management of the management device while achieving a simple configuration of the battery device.

(8) A computer program according to the embodiment is a computer program used for managing a battery device loaded in a vehicle. The computer program causes a computer to execute: a step of measuring an ON time of a battery module included in the battery device; a step of sending the ON time measured by the measuring unit so as to provide the ON time to a management device, the management device managing the ON time of the battery module; and a step of judging whether the battery module has been used outside management of the management device, based on the measured ON time and a reference value provided from the management device. The step of sending the measured ON time further includes sending of a judging result indicating whether the battery module has been used outside the management of the management device so as to provide the judging result to the management device. The ON time of the battery module can be measured with a simple configuration using an ON-time detection circuit and a timer. It is thus possible to judge whether the battery module has been used outside the management of the management device while achieving a simple configuration of the battery device.

### Details of Embodiment of Present Disclosure

Details of an embodiment of the invention will be described below with reference to the drawings. At least some parts of the embodiment may be combined with each other in a desired manner.

### 1. ON-Time Management System

An ON-time management system according to the embodiment is a system that obtains and manages the ON time of a battery (driving battery) loaded in a vehicle, such as an electric car, a hybrid car, and a plug-in hybrid car, which runs using electricity as driving power.

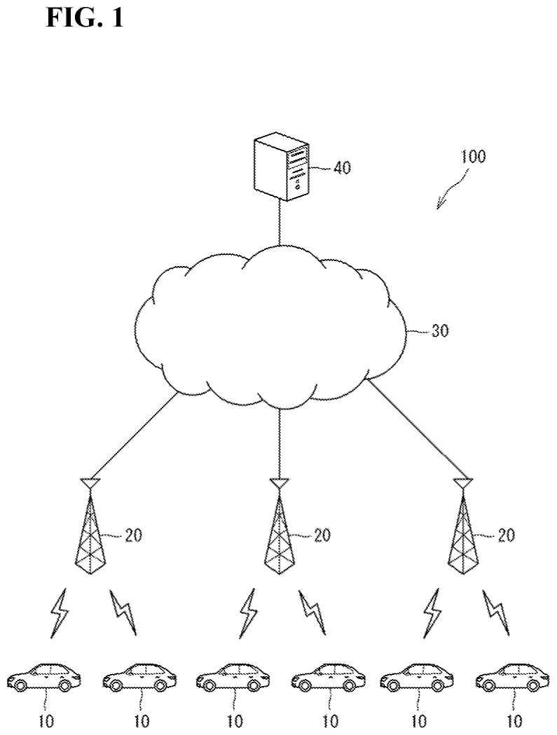

FIG. 1 is a schematic view illustrating an example of the ON-time management system according to the embodiment.

An ON-time management system 100 includes plural vehicles 10 and a server 40. The vehicles 10 each include a wireless communication device (external communication device 211, which will be discussed later) and is able to wirelessly communicate with a base station 20 (or a roadside unit). Base stations 20 are connected to the internet 30, and the server 40 is also connected to the internet 30. The vehicles 10 can perform data communication with the server 40.

The server 40 is an example of a management device. The server 40 has a database. For each vehicle 10, the server 40 stores the ON time of a battery module of a battery device in association with the device ID of the battery device. The vehicle 10 regularly or irregularly uploads, together with the device ID, the ON time of each battery module of the battery device loaded in the vehicle 10 to the server 40. The server 40 checks the device ID against that in the database and stores the received ON time in the database in association with the device ID. The ON time of a battery module of each vehicle 10 is managed in this manner.

### 2. In-Vehicle System

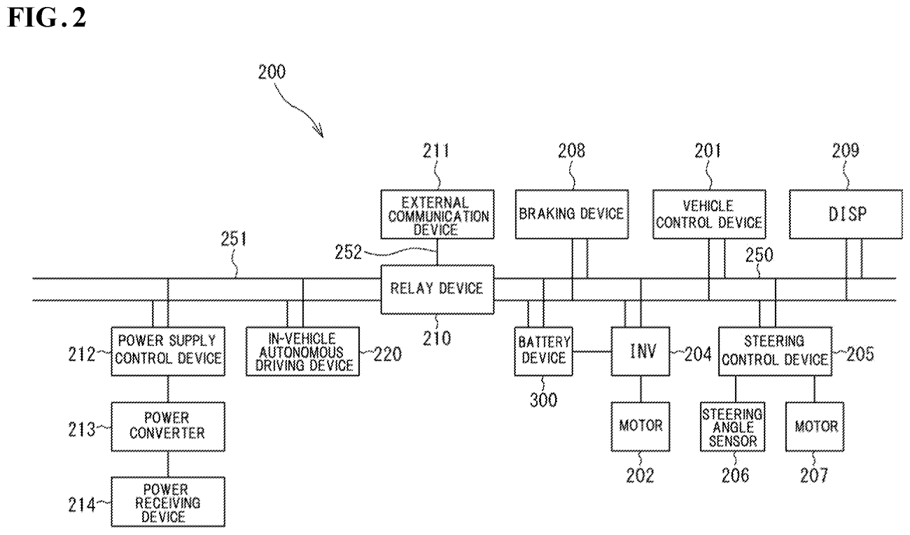

FIG. 2 is a block diagram illustrating an example of the configuration of an in-vehicle system loaded in a vehicle according to the embodiment.

An in-vehicle system 200 includes a vehicle control device 201, a motor 202, an inverter 204, a steering control device 205, a steering angle sensor 206, a motor 207, a braking device 208, a display device 209, a relay device 210, an external communication device 211, a power supply control device 212, a power converter 213, a power receiving device 214, an in-vehicle autonomous driving device 220, and a battery device 300, for example.

The motor 202 is connected to an axle and generates a driving torque for the vehicle 10. The battery device 300 includes a secondary battery, which is a driving battery for driving the vehicle 10. The inverter 204 is connected to the motor 202 and the battery device 300. The inverter 204 receives power from the battery device 300 and drives the motor 202. Regenerative power generated by the motor 202 during braking is returned to the battery device 300 via the inverter 204.

The steering control device 205 is connected to the steering angle sensor 206 and the motor 207. The steering control device 205 receives from the steering angle sensor 206 the value of the steering angle detected by the steering angle sensor 206 and controls the motor 207 that drives a power steering device, which is not shown. By controlling the motor 207, the steering control device 205 can adjust the steering angle of a steering wheel, that is, the angle of a tire, to change the traveling direction of the vehicle. The braking device 208 drives a braking mechanism, which is not shown, provided in the axle of the vehicle so as to generate a braking force in the running vehicle 10.

Upon receiving an instruction from the in-vehicle autonomous driving device 220, the vehicle control device 201 controls the motor 202 and provides a control instruction to the steering control device 205 in accordance with a target angle of a tire and a target velocity so as to drive the vehicle 10. If braking is required, the vehicle control device 201 controls the braking device 208 to generate a braking force in the vehicle 10. More specifically, in response to an instruction concerning a target angle of a tire from the in-vehicle autonomous driving device 220, the vehicle control device 201 provides a control instruction to the steering control device 205 based on the received instruction, and then, the steering control device 205 controls the motor 207 based on the control instruction and the value detected by the steering angle sensor, thereby setting the angle of a tire of the vehicle 10 to the target angle of the tire. In response to an instruction concerning a target driving velocity from the in-vehicle autonomous driving device 220, the vehicle control device 201 controls the motor 202 in accordance with this instruction so as to cause the vehicle 10 to run at the target driving velocity. In response to a braking instruction from the in-vehicle autonomous driving device 220, the vehicle control device 201 controls the motor 202 and the braking device 208 in accordance with this instruction so as to generate a braking force.

The display device 209 displays text information or an image, for example, in accordance with a display instruction from the vehicle control device 201, the in-vehicle autonomous driving device 220, or another device.

The power supply control device 212 is connected to the power converter 213, and the power converter 213 is connected to the power receiving device 214. The power receiving device 214 includes an inlet, which is not shown. The inlet is connectable to a charging connector (not shown) provided in a charging device installed in a parking lot or a house. While the charging connector is connected to the inlet, the power receiving device 214 receives power from the charging device. The power supply control device 212 controls the power converter 213. The power converter 213 includes an AC-to-DC converter and a DC-to-DC converter, for example. That is, the power converter 213 converts AC power received by the power receiving device 214 into DC power or converts the voltage of DC power received by the power receiving device 214. When the power receiving device 214 is connected to a charging device, it receives power from the charging device and outputs power to the power converter 213. Under the control of the power supply control device 212, the power converter 213 converts power received from the power receiving device 214 into DC power of a predetermined voltage and outputs DC power to the battery device 300.

The vehicle control device 201, the inverter 204, the steering control device 205, the braking device 208, the display device 209, and the battery device 300 are connected to a bus 250, such as a CAN bus, and the relay device 210 is connected to the bus 250. The in-vehicle autonomous driving device 220 and the power supply control device 212 are connected to a bus 251, such as a CAN bus, and the relay device 210 is connected to the bus 251.

The relay device 210 relays communication between in-vehicle devices via an in-vehicle network, such as the buses 250 and 251. That is, the vehicle control device 201, the inverter 204, the steering control device 205, the braking device 208, the display device 209, the in-vehicle autonomous driving device 220, and the battery device 300 can communicate with each other via the relay device 210. The relay device 210 is connected to the external communication device 211 via a communication line 252.

The external communication device 211 is able to perform wireless communication. The external communication device 211 wirelessly communicates with external devices, such as a roadside unit, a terminal, the base station 20, and the server 40.

### 3. Battery Management System

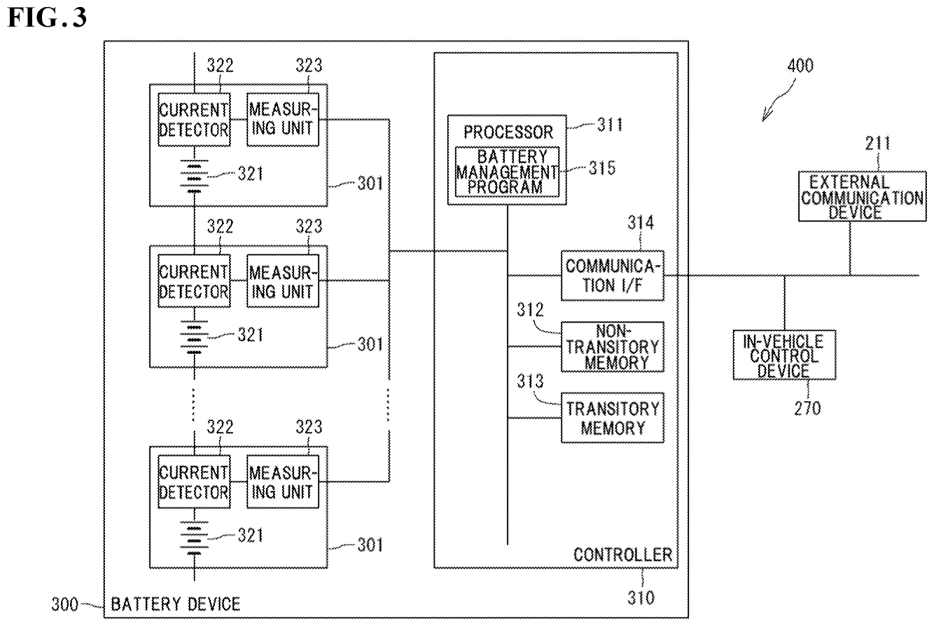

FIG. 3 is a block diagram illustrating an example of the configuration of a battery management system according to the embodiment. A battery management system 400 is part of the in-vehicle system 200.

The battery management system 400 according to the embodiment includes the battery device 300. For example, the battery management system 400 includes the battery device 300, an in-vehicle control device 270, and the external communication device 211.

In the battery management system 400 according to the embodiment, the in-vehicle control device 270 is an example of a management device. That is, the in-vehicle control device 270 has a database similar to that of the server 40.

The battery device 300 measures the ON time of a battery module and judges whether the battery module has been used outside the management of the management device, based on the measured ON time. The battery device 300 sends the measured ON time and the judging result. The ON time and the judging result sent by the battery device 300 are received by the in-vehicle control device 270 and are registered in the database. The ON time and the judging result are also sent to the server 40 via the external communication device 211 and is registered in the database.

The in-vehicle control device 270 is an in-vehicle device different from the battery device 300. For example, the in-vehicle control device 270 may be the vehicle control device 201, the steering control device 205, the relay device 210, or the in-vehicle autonomous driving device 220.

The configuration of the battery device 300 according to the embodiment will be described below. The battery device 300 includes plural battery modules 301 and a controller 310.

Each battery module 301 includes a secondary battery 321, a current detector 322, and a measuring unit 323. That is, one battery module 301 includes one current detector 322 and one measuring unit 323. The secondary battery and the current detector 322 are connected in series with each other. The measuring unit 323 is connected to the current detector 322.

The current detector 322 detects a current output from the secondary battery 321. In one specific example, the current detector 322 detects that a current of a prescribed value or greater is output from the secondary battery 321. The measuring unit 323 measures the ON time of the battery module 301. In one specific example, the measuring unit 323 measures, as the ON time, the time for which a current of a prescribed value or greater is output. The ON time measured by the measuring unit 323 is a cumulative value of the ON time. That is, the measuring unit 323 measures the cumulative value of the ON time from when the battery device 300 is loaded in the vehicle 10 and is started for use until the present time.

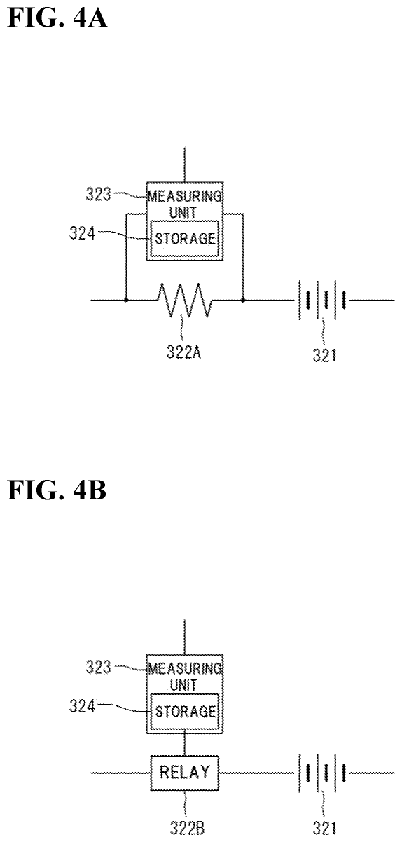

FIG. 4A is a circuit diagram illustrating an example of the configuration of the battery module according to the embodiment. FIG. 4B is a circuit diagram illustrating another example of the configuration of the battery module according to the embodiment.

In the example in FIG. 4A, the current detector 322 includes a shunt resistor 322A. The shunt resistor 322A shunts the output current of the secondary battery 321 to the measuring unit 323. In this example, the measuring unit 323 determines the output current of the secondary battery 321, and if the output current is found to be equal to a threshold (prescribed value) or greater, the measuring unit 323 measures the ON time.

In the example in FIG. 4B, the current detector 322 includes a mechanical relay 322B. The mechanical relay 322B turns OFF its switch when the value of a current output from the secondary battery 321 is smaller than the threshold and turns ON its switch when the value of the current is greater than or equal to the threshold. The mechanical relay 322B is connected to the measuring unit 323. While the switch of the mechanical relay 322B is OFF, an electric signal is not output from the mechanical relay 322B to the measuring unit 323. While the switch of the mechanical relay 322B is ON, an electric signal is output from the mechanical relay 322B to the measuring unit 323. The measuring unit 323 does not measure the ON time while no electric signal is being input and measures the ON time while an electric signal is being input.

The measuring unit 323 is a hardware logic circuitry, such as an ASIC (Application Specific Integrated Circuit), a gate array, or an FPGA (Field Programmable Gate Array). The measuring unit 323 includes a timer, which is not shown. In the examples in FIGS. 4A and 4B, the measuring unit 323 includes a storage 324. The storage 324 is a rewritable non-transitory memory, for example. The measuring unit 323 stores the measured ON time in the storage 324.

Reference is now back to FIG. 3. In one specific example, the controller 310 includes a processor 311, a non-transitory memory 312, a transitory memory 313, and a communication interface 314.

The transitory memory 313 is a volatile memory, such as an SRAM (Static Random Access Memory) and a DRAM (Dynamic Random Access Memory). The non-transitory memory 312 is a non-volatile memory, such as a flash memory, a hard disk, and a ROM (Read Only Memory). In the non-transitory memory 312, a battery management program 315, which is a computer program, and data used for the execution of the battery management program 315 are stored. The battery device 300 includes a computer, and the individual functions of the battery device 300 are implemented as a result of the processor 311, which is a CPU, executing the battery management program 315, which is a computer program stored in a storage of the computer. The battery management program 315 may be stored in a recording medium, such as a flash memory, a ROM, and a CD-ROM. The processor 311 executes the battery management program 315 and judges whether any battery module 301 has been used outside the management of the management device. This judgement will be discussed later.

The processor 311 is not limited to a CPU. The processor 311 may be a hardware logic circuitry, such as an ASIC, a gate array, and an FPGA. In this case, the hardware logic circuitry is configured to execute processing similar to the battery management program 315.

The communication interface 314 is connected to the bus 250 of the in-vehicle network. The battery device 300 can communicate with other devices, such as the in-vehicle control device 270 and the external communication device 211, via the bus 250.

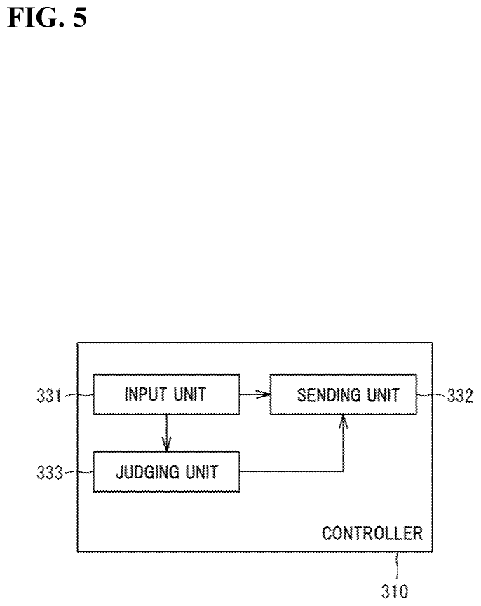

FIG. 5 is a functional block diagram illustrating an example of the functions of the controller 310 of the battery device 300 according to the embodiment. The controller 310 includes functions which serve as an input unit 331, a sending unit 332, and a judging unit 333.

The input unit 331 receives the ON time of each battery module 301 measured by the measuring unit 323. The input unit 331 also receives a reference value sent from the server 40 or the in-vehicle control device 270. The reference value is used by the judging unit 333. The reference value is a value based on past ON times managed by the server 40 or the in-vehicle control device 270. In one specific example, the reference value indicates the ON time measured last time, that is, the latest one of the past ON times managed by the server 40 or the in-vehicle control device 270.

The sending unit 332 sends the ON time of each battery module 301 received by the input unit 331 so as to provide the ON time to the server 40 or the in-vehicle control device 270. The sending unit 332 sends the device ID of the battery device 300, together with a set of ON times (ON times of the individual battery modules). For example, the sending unit 332 sends the ON times and the device ID when the driver has finished driving the vehicle 10, that is, during shutdown processing of the in-vehicle system 200. The sent device ID and ON times are received by the in-vehicle control device 270 and the external communication device 211. The external communication device 211 uploads the received device ID and ON times to the server 40.

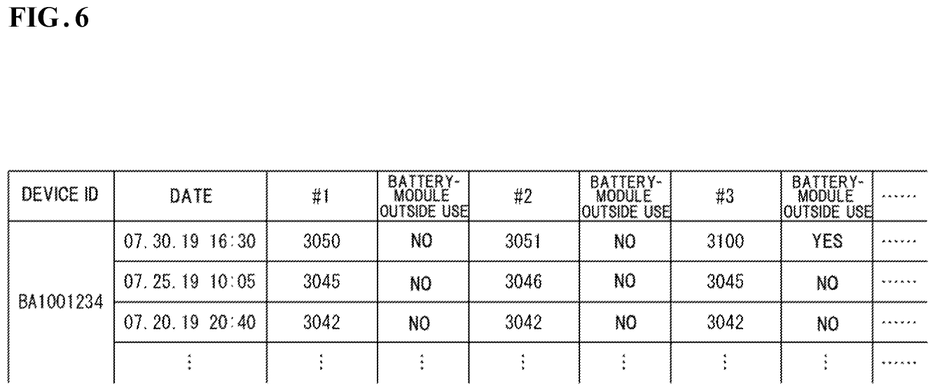

The server 40 and the in-vehicle control device 270 each register the received ON times in the database. FIG. 6 is a diagram illustrating an example of the configuration of the database provided in each of the server and the in-vehicle control device according to the embodiment. In the database provided in each of the server 40 and the in-vehicle control device 270, the device ID, the registration date (that is, the time and date when the in-vehicle system 200 shuts down), the ON time, and the judging result regarding whether the battery module has been used outside the management of the management device are stored. A record of the ON time and the judging result regarding the outside use of the battery module is registered according to the date. In the example in FIG. 6, for the device ID “BA1001234”, a record of the registration date “07. 30. 19 16:30”, a record of the registration date “07. 25. 19 10:05”, and a record of the registration date “07. 20. 19 20:40” are stored. In the record of the registration date “07. 30. 19 16:30”, the ON time of the first battery module is 3050 hours and the judging result regarding the outside use of the first battery module is “NO”; the ON time of the second battery module is 3051 hours and the judging result regarding the outside use of the second battery module is “NO”; and the ON time of the third battery module is 3100 hours and the judging result regarding the outside use of the third battery module is “YES”. In the record of the registration date “07. 25. 19 10:05”, the ON time of the first battery module is 3045 hours and the judging result regarding the outside use of the first battery module is “NO”; the ON time of the second battery module is 3046 hours and the judging result regarding the outside use of the second battery module is “NO”; and the ON time of the third battery module is 3045 hours and the judging result regarding the outside use of the third battery module is “NO”. In the record of the registration date “07. 20. 19 20:40”, the ON time of the first battery module is 3042 hours and the judging result regarding the outside use of the first battery module is “NO”; the ON time of the second battery module is 3042 hours and the judging result regarding the outside use of the second battery module is “NO”; and the ON time of the third battery module is 3042 hours and the judging result regarding the outside use of the third battery module is “NO”.

The server 40 manages, by using its database, the ON times of the plural battery devices 300 installed in the respective vehicles 10. The in-vehicle control device 270 manages, by using its database, only the ON times of the battery device 300 of the vehicle 10 in which the in-vehicle control device 270 is disposed.

Reference is now back to FIG. 5. The judging unit 333 judges whether a battery module 301 has been used outside the management of the management device, based on the ON time of the battery module 301 measured by the measuring unit 323. In one specific example, the judging unit 333 judges whether a battery module 301 has been used outside the management of the management device, by comparing the ON time received by the input unit 331 with the reference value received by the input unit 331. Hereinafter, processing for judging whether a battery module 301 has been used outside the management of the management device will be called “battery-module outside use judging processing”.

The function of the judging unit 333 when the reference value indicates the latest ON time will be discussed below. The server 40 (or the in-vehicle control device 270) sends the latest ON time of each battery module 301 as the reference value. That is, the reference value of each battery module 301 is provided from the server 40 (or the in-vehicle control device 270). The judging unit 333 selects one battery module and compares the ON time of this battery module with the corresponding reference value.

The reference value indicates the ON time at a time when the in-vehicle system 200 shut down last time. The judging unit 333 executes battery-module outside use judging processing while the in-vehicle system 200 is in operation. In one specific example, the judging unit 333 executes battery-module outside use judging processing when the in-vehicle system 200 is started. While the in-vehicle system 200 is OFF, namely, for a period from when the in-vehicle system 200 shut down last time until when the in-vehicle system 200 is started this time, the battery modules 301 are not ON, or even if they are ON, they are ON only for a limited time. For example, while the in-vehicle system 200 is OFF, updating of a control program for the in-vehicle devices may be executed. In this case, power is supplied from the battery modules 301 to the in-vehicle devices during the execution of updating processing. Accordingly, while updating processing is being executed, the battery modules 301 are ON. Unlike this case, if a battery module 301 is removed from the battery device 300 and is illegally used, it is likely that the removed battery module 301 will be used for a long time. The ON time of the battery module 301 thus becomes longer.

In one specific example of battery-module outside use judging processing executed by the judging unit 333, it is judged whether the difference between the ON time and the reference value is within a certain allowance range. The allowance range is determined by considering the period of time for updating processing of the control program for the in-vehicle devices. If the difference between the ON time and the reference value is within the allowance range, it can be judged that the battery module 301 has not been used outside the management of the management device. In contrast, if the difference between the ON time and the reference value extends from the allowance range, it can be judged that the battery module 301 has been used outside the management of the management device, such as that the battery module 301 has been removed from the battery device 300 and used.

The sending unit 332 sends the result of battery-module outside use judging processing (hereinafter called “the battery-module outside use judging result”) executed by the judging unit 333. For example, the battery-module outside use judging result is sent together with the ON time and the device ID. The battery-module outside use judging result is received by the server 40 and the in-vehicle control device 270 and is registered in their databases.

### 4. Operation of Battery Management System

The operation of the battery management system 400 according to the embodiment will be described below. The operation of the measuring unit 323 will first be discussed.

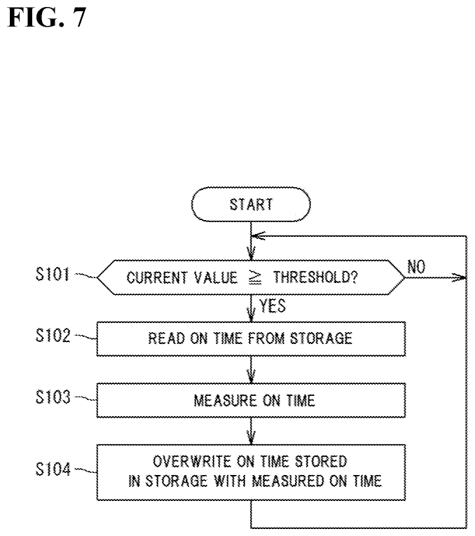

FIG. 7 is a flowchart illustrating the operation procedure of the measuring unit 323 according to the embodiment. In each battery module 301, the current detector 322 detects a current output from the secondary battery 321 (step S101). If the current value of the secondary battery 321 is smaller than a threshold (NO in step S101), the measuring unit 323 returns to step S101. Step S101 is repeatedly executed until a current of a value greater than or equal to the threshold is output from the secondary battery 321 (that is, until the battery module 301 is turned ON).

If the current value of the secondary battery 321 is greater than or equal to the threshold (YES in step S101), the measuring unit 323 reads the ON time from the storage 324 (step S102). The ON time stored in the storage 324 is the ON time measured last time.

Then, the measuring unit 323 measures the ON time (step S103). That is, the measuring unit 323 measures the time elapsed from the time point when the current value has become greater than or equal to the threshold in step S101 by using a timer, and then adds the time measured by the timer to the latest ON time read in step S102, thereby calculating the new ON time.

The measuring unit 323 overwrites the ON time stored in the storage 324 with the newly measured ON time (step S104). After step S104, step S101 is re-executed. By repeating the above-described loop of steps S101 through S104, the ON time is updated while the battery module 301 is ON.

The operation of the controller 310 will now be described below. The processor 311 of the controller 310 starts the battery management program 315 to execute the following battery-module outside use judging processing and ON-time providing processing.

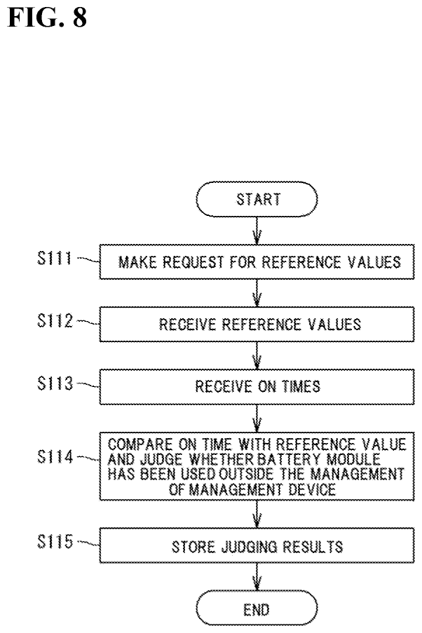

FIG. 8 is a flowchart illustrating an example of a procedure of battery-module outside use judging processing executed by the controller 310 according to the embodiment.

In one specific example, battery-module outside use judging processing is executed when the in-vehicle system 200 is started. In battery-module outside use judging processing, the processor 311 first requests the server 40 or the in-vehicle control device 270 to send reference values (step S111). For example, basically, the processor 311 requests the server 40 to send reference values, and if no response is returned from the server 40 after the lapse of a predetermined time, the processor 311 can request the in-vehicle control device 270 to send reference values.

In response to the request, the server 40 or the in-vehicle control device 270 sends the reference value for each battery module 301. This reference value represents the latest ON time of the corresponding battery module 301 registered in the database. The controller 310 receives the sent reference values (step S112).

The processor 311 requests the measuring unit 323 to send the ON time of each battery module 301 and receives the individual ON times (step S113). Each of the ON times received in step S113 is the latest ON time at the time point when the in-vehicle system 200 is started. That is, if the ON time is not measured while the in-vehicle system 200 is OFF, the ON time at the time point when the in-vehicle system 200 shut down last time is provided to the controller 310. If the ON time is measured while the in-vehicle system 200 is OFF, this ON time is provided to the controller 310.

The processor 311 then compares, for each battery module 301, the ON time with the reference value and judges whether the battery module 301 has been used outside the management of the management device (step S114). The processor 311 stores the battery-module outside use judging results in the non-transitory memory 312 or the transitory memory 313 (step S115). Battery-module outside use judging processing is then completed.

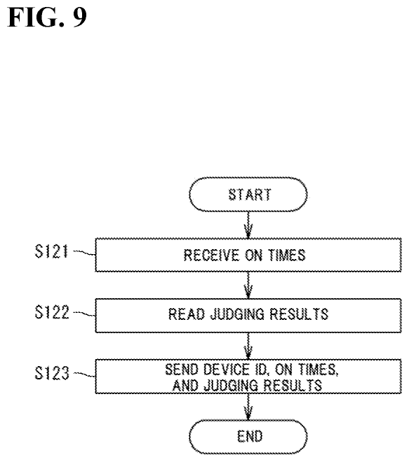

FIG. 9 is a flowchart illustrating an example of a procedure of ON-time providing processing executed by the controller 310 according to the embodiment.

In one specific example, the ON-time providing processing is executed during shutdown processing of the in-vehicle system 200. In the ON-time providing processing, the processor 311 first requests the measuring unit 323 to send the ON time of each battery module 301 and receives the ON times (step S121). Each of the ON times received in step S121 is the latest ON time measured while the in-vehicle system 200 is running, that is, for the period from when the in-vehicle system 200 is started until it shuts down. That is, the latest ON time at the time point of shutdown processing of the in-vehicle system 200 is provided to the controller 310.

Then, the processor 311 reads the battery-module outside use judging results from the non-transitory memory 312 or the transitory memory 313 (step S122). The processor 311 then sends the device ID, the ON time of each battery module 301, and the battery-module outside use judging result of each battery module (step S123). The sent ON times and battery-module outside use judging results are registered in the database of the server 40 or the in-vehicle control device 270. The ON-time providing processing is then completed.

### 5. Modified Examples

The configuration and the operation of the battery management system according to the present disclosure are not restricted to those discussed in the embodiment. Only the server 40 may be used as the management device, and the in-vehicle control device 270 may not be used as the management device. That is, the database for the ON times and the battery-module outside use judging results may be provided only for the server 40. This makes it possible to store the ON times and the battery-module outside use judging results in the server 40, which is robust for unauthorized access, and thus to reduce falsification of information. In contrast, only the in-vehicle control device 270 may be used as the management device, and the server 40 may not be used as the management device. That is, the database for the ON times and the battery-module outside use judging results may be provided only for the in-vehicle control device 270. This makes it possible to register and manage the ON times and the battery-module outside use judging results even in a situation where wireless communication with external devices is disabled.

The reference value represents the ON time measured last time, but the reference value is not limited to this. For example, the ON time at a specific time point (the present time, for example) that can be estimated from the ON times at multiple past time points may be used as the reference value. In another example, a value different from the latest ON time, such as the ON time before the last, may be used as the reference value.

In the embodiment, the sending unit 332 is disposed in the battery device 300. The external communication device 211 is also an example of the sending unit. That is, when the server 40 is used as the management device, the external communication device 211 serves as a sending unit that sends the ON times and the battery-module outside use judging results to the server 40.

### 6. Advantages

As described above, the battery management system 400 includes the measuring unit 323, the sending unit 332, and the judging unit 333. The measuring unit 323 measures the ON time of a battery module 301 included in the battery device 300. The measuring unit 323 is included in the battery device 300. The sending unit 332 sends the ON time measured by the measuring unit 323 to the server 40 or the in-vehicle control device 270 that manages the ON time of the battery module 301. The judging unit 333 determines the difference between the ON time measured by the measuring unit 323 and a reference value provided by a management device so as to judge whether the battery module 301 has been used outside the management of the management device. The sending unit 332 also sends a judging result determined by the judging unit 333 to the management device. The ON time of the battery module 301 can be measured with a simple configuration using the current detector 322 and a timer. It is thus possible to judge whether the battery module 301 has been used outside the management of the management device while achieving a simple configuration of the battery device 300.

To manage the ON time of the battery module 301, the management device provides an appropriate reference value. The use of such a reference value can accurately judge whether the battery module 301 has been used outside the management of the management device.

The reference value may be a value based on a past ON time sent from the sending unit 332 to the management device. When the battery module 301 is used outside the management of the management device, the ON time of the battery module 301 is measured but is not sent to the management device. Hence, after the battery module 301 is used outside the management of the management device, when the battery module 301 is used again under the management of the management device, the resulting measured ON time becomes considerably different from the past ON time sent to the management device. As a result of setting the reference value to a value based on the past ON time sent to the management device, the difference between a currently measured ON time and the past ON time can be determined, thereby making it possible to accurately judge whether the battery module 301 has been used outside the management of the management device.

The measuring unit 323 may measure the ON time for a period from when the in-vehicle system 200 loaded in the vehicle 10 is started until when it shuts down. The sending unit 332 may send the ON time at a timing when the in-vehicle system 200 shuts down. With this configuration, the ON time is sent to the management device when the in-vehicle system 200 shuts down, that is, when the driver finishes driving the vehicle 10. This can make the time interval from when the ON time is sent last time until when the ON time is measured this time small. It is thus possible to even more accurately judge whether the battery module 301 has been used outside the management of the management device. If the in-vehicle system is started multiple times, the ON time may be the cumulative value of the past ON times. That is, the value of the ON time measured at the shutdown time of the in-vehicle system may be retained, and when the in-vehicle system is started next time, measurement may be restarted from the retained value of the ON time.

At a timing when the in-vehicle system 200 is started, the judging unit 333 may obtain the reference value from the management device and judge whether the battery module 301 has been used outside the management of the management device. With this configuration, when the in-vehicle system 200 is started, that is, when the driver starts driving the vehicle, the judging unit 333 makes the above-described judgement. This can make the time interval from when the ON time is sent last time until when the ON time is measured this time even smaller. It is thus possible to even more accurately judge whether the battery module 301 has been used outside the management of the management device.

The measuring unit 323 may measure the ON time when a current of a prescribed value or greater is output from the battery module 301. With this configuration, the ON state and the OFF state of the battery module 301 can be clearly distinguished from each other. The ON time can thus be measured accurately.

### 7. Appendix

A battery management method executed by a battery device and a management device communicating with the battery device, comprising:

a step of measuring by the battery device an ON time of a battery module of the battery device;

a step of repeating by the battery device processing for recording the measured ON time in a memory of the battery device and processing for inputting the measured ON time into a communication unit of the battery device;

a step of storing by the management device the ON time received from the battery device;

a step of sending by the management device the stored ON time to the battery device; and

a step of calculating by the battery device a difference between the ON time received from the management device and the ON time recorded in the memory.

With this configuration, the calculated difference can be used for judging whether the battery module 301 has been used outside the management of the management device.

### 8. Supplementary Note

The foregoing description of the disclosed embodiment is only an example and is not intended to limit the invention. It is intended that the scope of the invention be defined, not by the foregoing embodiment, but by the following claims. The scope of the invention is to be accorded the broadest interpretation so as to encompass all such modifications and equivalent structures and functions.

### REFERENCE SIGNS LIST

10 vehicle

20 base station

30 internet

40 server

100 ON-time management system

200 in-vehicle system

201 vehicle control device

202 motor

204 inverter

205 steering control device

206 steering angle sensor

207 motor

208 braking device

209 display device

210 relay device

211 external communication device

212 power supply control device

213 power converter

214 power receiving device

220 in-vehicle autonomous driving device

250, 251 bus

252 communication line

270 in-vehicle control device

300 battery device

301 battery module

310 controller

311 processor

312 non-transitory memory

313 transitory memory

314 communication interface

315 battery management program

321 secondary battery

322 current detector

322A shunt resistor

322B mechanical relay

323 measuring unit

324 storage

331 input unit

332 sending unit

333 judging unit

400 battery management system

1. A battery management system managing a battery device loaded in a vehicle, comprising:
a sensor configured to measure an ON time of a battery module included in the battery device, the sensor being included in the battery device;
a communication device configured to send the ON time measured by the sensor to a management device, the management device managing the ON time of the battery module and receive a reference value from the management device; and
a circuitry configured to judge whether the battery module has been used outside management of the management device, based on the ON time measured by the sensor and the reference value,
wherein the communication device also sends a judging result determined by the circuitry to the management device.

2. The battery management system according to claim 1, wherein the reference value is a value based on the ON time of the battery module of a past sent from the communication device to the management device.

3. The battery management system according to claim 2, wherein:
the sensor measures the ON time for a period from when an in-vehicle system loaded in the vehicle is started until when the in-vehicle system shuts down; and
the communication device sends the ON time at a timing when the in-vehicle system shuts down.

4. The battery management system according to claim 3, wherein, at a timing when the in-vehicle system is started, the circuitry obtains the reference value from the management device and judges whether the battery module has been used outside the management of the management device.

5. The battery management system according to claim 1, wherein the sensor measures the ON time when a current of a prescribed value or greater is output from the battery module.

6. A battery device loaded in a vehicle, comprising:
a battery module;
a sensor configured to measure an ON time of the battery module;
a communication device configured to send the ON time measured by the sensor so as to provide the ON time to a management device, the management device managing the ON time of the battery module and receive a reference value from the management device; and
a circuitry configured to judge whether the battery module has been used outside management of the management device, based on the ON time measured by the sensor and the reference value,
wherein the communication device also sends a judging result determined by the circuitry so as to provide the judging result to the management device.

7. A battery management method for managing a battery device loaded in a vehicle, comprising:
measuring an ON time of a battery module included in the battery device;
sending the measured ON time to a management device, the management device managing the ON time of the battery module;
receiving a reference value from the management device; and
judging whether the battery module has been used outside management of the management device, based on the measured ON time and a reference value provided from the management device,
wherein the battery management method of sending the measured ON time further includes sending of a judging result indicating whether the battery module has been used outside the management of the management device to the management device.

8. (canceled)
